(19) United States
(12) Patent Application Publication
(10) Pub. No.: US 2023/0290567 A1
(43) Pub. Date: Sep. 14, 2023

(54) VARIABLE-IMPEDANCE ELECTRIC TRANSFORMER

(71) Applicant: PROLEC-GE INTERNACIONAL, S. DE R. L. DE C. V., Nuevo Leon (MX)

(72) Inventor: Enrique BETANCOURT RAMIREZ, Nuevo Leon (MX)

(21) Appl. No.: 18/013,923

(22) PCT Filed: Jul. 2, 2020
(86) PCT No.: PCT/IB2020/056235

§ 371 Date: Dec. 30, 2022

(51) Int. Cl. H01F 29/04; H01F 27/38; H01F 29/02

(52) U.S. Cl. CPC H01F 29/04; H01F 27/38; H01F 29/025

(57) ABSTRACT

Disclosed is an electric transformer that has variable impedance, optionally under load, which includes, in at least one of its transformation phases, a first impedance-varying auxiliary winding having inverse magnetic polarity arid a second impedance-varying auxiliary winding having inverse magnetic polarity, both auxiliary windings being divided into impedance circuit modules and being series connected by interposing the impedance circuit modules one by one, defining impedance variation modules that comprise impedance taps designed to be electrically coupled to a stepped-impedance-tap selector controlled by an impedance controller that allows the impedance of the transformation phase or of the electric transformer to be varied,

### TECHNICAL FIELD OF THE INVENTION

The present invention refers to electric transformers, more specifically, it refers to a variable-impedance electric transformer using impedance-varying auxiliary windings connected in series and having inverse magnetic polarity, and whose circuit modules are interposed and controlled by a single stepped-impedance-tap selector per transformation phase.

### BACKGROUND OF THE INVENTION

At present, in electric transformers, either power or distribution, which have transformation phases made up of primary and secondary windings wound around a magnetic core, it is common for them to incorporate auxiliary windings configured to conduct electric current around the same core magnetic to vary, either the electrical voltage or the impedance, of one or more of the transformation phases or of the electric transformer itself.

An example of implementation of a variable-impedance electric transformer using auxiliary windings is the one described by Hiromichi Sato et al. in Japanese

Patent Application Publication JP-2001044051, where a variable-impedance electric transformer having a magnetic flux control circuit is shown, where a primary winding and a secondary winding are wound on a magnetic core. In one part of the magnetic core there is a window or hole, in which two control coils, connected in series, are wound around two sides of the window. An induced electric voltage is generated in the control coils, but these, being connected in series, cancel the induced electric voltage. Consequently, an induced electric voltage is not applied to a control circuit. The winding structure is like an ordinary single-phase transformer, but with the difference that it includes a controllable flux magnetic control circuit consisting of a window with control coils, a magnetic core, and a control circuit.

Another example of the application of auxiliary windings in an electric transformer is described by Jesús Ávila et al. in the Mexican patent MX-293203, where an electric transformer of controlled electric voltage is shown that has a magnetic core; at least one primary winding supplied with a main current to generate a main magnetic flux on the magnetic core; at least one secondary winding; and at least one magnetic distortion field generator supplied with a control current for generating a magnetic distortion field on the magnetic core, such that the control current has an intensity that varies in relation to the detection of the output electric voltage required in relation to the operating load of electric transformer; such that the magnetic distortion field combines with the main magnetic flux generating a distortion of it, achieving a change in the reluctance of the magnetic core and thus a change in the output electrical voltage of the electric transformer.

A further example of the application of auxiliary windings in an electric transformer is described by William James Premerlani et al. in US patent application publication US2018/0330862A1. This patent application describes an electric transformer that includes conductive windings (primary and secondary windings) and impedance-varying windings (auxiliary windings) that extend around a magnetic core of a transformation phase, and an impedance switch for each transformation phase. Conductive windings and impedance-varying windings are configured to conduct electric current around the magnetic core of the transformation phase. The impedance switch is actuated to alter any of the impedance-varying windings that are conductively coupled with the conductive windings, and any of the impedance-varying windings that are disconnected from the conductive windings. For example, the impedance switch can connect a tap from any of the taps on each transformation phase to add one or more circuit pairs of the odd and even windings in series with the lead windings to increase or decrease the leakage impedance of the electric transformer. Furthermore, each impedance switch corresponding to each transformation phase of the electric transformer can be turned on and changed to the same setting to change the leakage impedance of the electric transformer.

Another example of the application of auxiliary windings in an electric transformer is described by Ibrahima Ndiaye et al. in U.S. patent application Ser. No. 16/689,438. This patent application describes an electric transformer that includes conductive windings (primary and secondary windings); impedance-varying windings (auxiliary windings) formed in turn by positive windings and negative windings; both the conductive windings and the impedance-varying windings extend around a magnetic core of a transformation phase and are configured to conduct electric current around the magnetic core of the transformation phase; a first impedance tap changer configured to electrically couple to the positive windings of the impedance-varying windings; a second impedance tap changer configured to electrically couple to the negative windings of the impedance-varying windings; and an impedance controller configured to control the first impedance tap changer and the second impedance tap changer to change an impedance of the electric transformer. The impedance controller controls the operation of the first impedance tap changer and the second impedance tap changer, directing the first impedance tap changer and the second impedance tap changer to couple with a first portion of the impedance-varying windings selectively and electrically. For example, the first impedance tap changer may be electrically coupled with a positive winding portion and the second impedance tap changer may be electrically coupled with a negative winding portion of the impedance-varying windings. Subsequently, the impedance controller may direct the first impedance tap changer and the second impedance tap changer to couple to a different portion of the positive windings and negative windings of the impedance-varying windings selectively and electrically, respectively.

Although the electric transformers described above allow flexibility in the variation, either of the electric voltage and/or of the impedance, of one or more of the transformation phases or of the electrical transformer itself, its complexity in the design, configuration, internal trace and interconnection of the conductive windings and impedance-varying windings is very high, which implies, for example, the use of a second impedance tap changer, which leads to oversizing and increased weight of the electric transformer and therefore hence higher manufacturing cost.

In view of the limitation found, it is therefore necessary to offer a variable-impedance electric transformer with a new interconnection configuration of its auxiliary windings (impedance-varying windings), in such a way that only a stepped-impedance-tap selector is used per transformation phase, to significantly reduce the degree of complexity of the internal trace of the same electric transformer.

### SUMMARY OF THE INVENTION

In view of what has been previously described and with the purpose of solving the limitations found, it is the object of the invention to offer a variable-impedance electric transformer, comprising one or more transformation phases extending around a magnetic core, at least one transformation phase includes conductive windings; a first impedance-varying auxiliary winding divided into impedance circuit modules, the first impedance-varying auxiliary winding having a magnetic polarity; a second impedance-varying auxiliary winding divided into impedance circuit modules, the second impedance-varying auxiliary winding having an inverse magnetic polarity to the magnetic polarity of the first impedance-varying auxiliary winding; the first impedance-varying auxiliary winding and second impedance-varying auxiliary winding are connected in series, defining impedance variation modules by interposing the impedance circuit modules one by one, each impedance variation module includes one impedance circuit modules of the first impedance-varying auxiliary winding connected in series with one impedance circuit modules of the second impedance-varying auxiliary winding, and each impedance variation module having a impedance tap; a stepped-impedance-tap selector configured to be electrically coupled to the impedance taps of the impedance variation modules; and an impedance controller configured to control the stepped-impedance-tap selector for varying the impedance of the transformation phase or the electric transformer.

It is also an object of the present invention to provide a method for varying the impedance in an electric transformer comprising one or more transformation phases extending around a magnetic core, the method includes the steps of: (a) disposing conductive windings; (b) disposing a first impedance-varying auxiliary winding divided into impedance circuit modules, the first impedance-varying auxiliary winding having a magnetic polarity; (c) disposing a second impedance-varying auxiliary winding divided into impedance circuit modules, the second impedance-varying auxiliary winding having an inverse magnetic polarity to the magnetic polarity of the first impedance-varying auxiliary winding; (d) connecting the first impedance-varying auxiliary winding and second impedance-varying auxiliary winding in series, by interposing the impedance circuit modules one by one for defining impedance variation modules, each impedance variation module includes one impedance circuit modules of the first impedance-varying auxiliary winding connected in series with one impedance circuit modules of the second impedance-varying auxiliary winding, and each impedance variation module having a impedance tap; (e) electrically coupling a stepped-impedance-tap selector to the impedance taps of the impedance variation modules; and (f) controlling, by an impedance controller, the stepped-impedance-tap selector for varying the impedance of the transformation phase or the electric transformer.

### BRIEF DESCRIPTION OF THE DRAWINGS

The characteristic details of the invention are described in the following paragraphs together with the accompanying figures, which are for the purpose of defining the invention, but without limiting its scope.

FIG. 1 illustrates a sectioned perspective view of a variable-impedance electric transformer in accordance with the present invention.

FIG. 2A illustrates a perspective view of a first embodiment of a magnetic core and its transformation phases of a variable-impedance column-type electric transformer in accordance with the present invention.

FIG. 2B illustrates a perspective view of a second embodiment of a magnetic core and its transformation phases of a variable-impedance armored-type electric transformer in accordance with the present invention.

FIG. 3 illustrates a circuit diagram of one embodiment of a transformation phase of a variable-impedance electric transformer, either column-type or armored-type, in accordance with the present invention: and

FIG. 4 illustrates a flowchart of a method for varying the impedance of an electrical transformer, either column type or armored type, in accordance with the present invention.

### DETAILED DESCRIPTION OF THE INVENTION

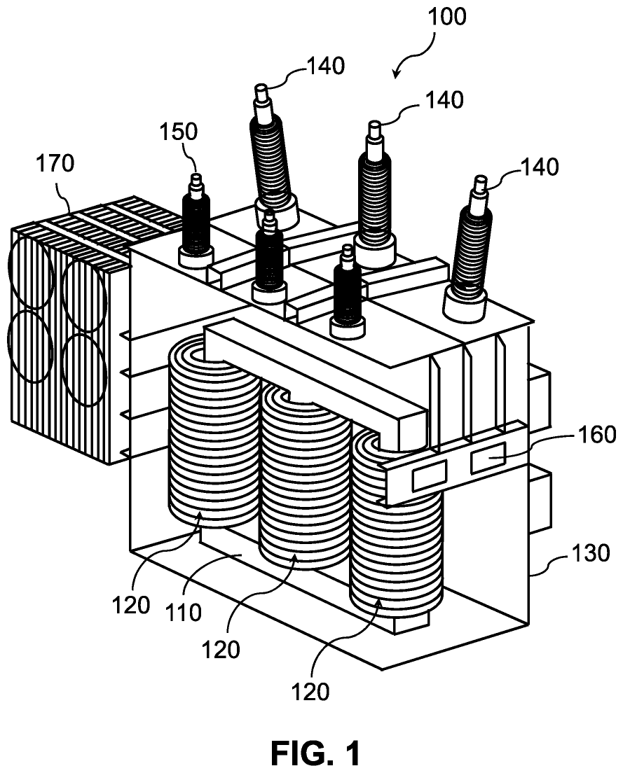

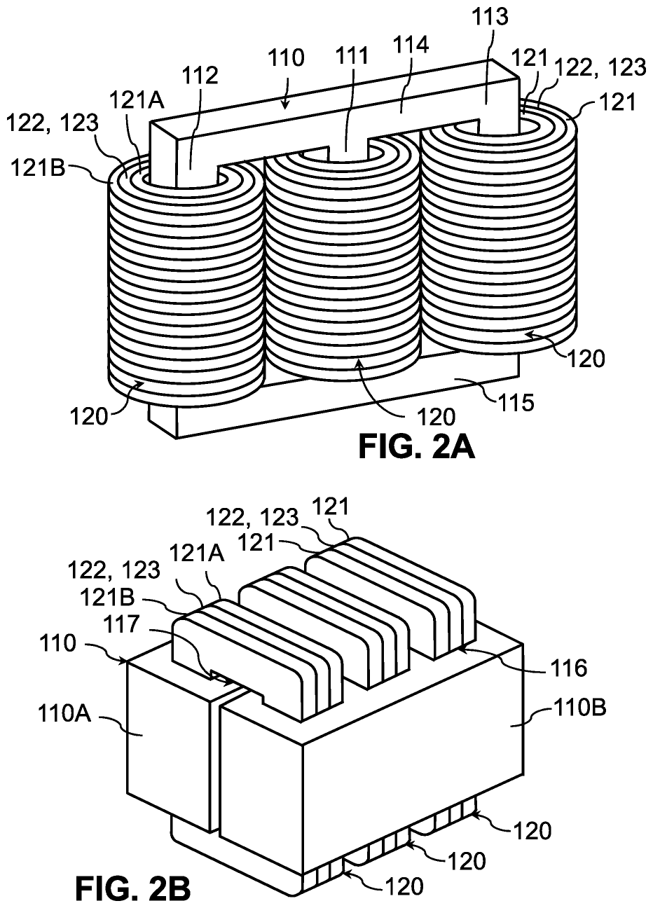

Referring to FIG. 1, a sectioned perspective view of a variable-impedance electric transformer 100 in accordance with the present invention is illustrated. The electric transformer 100 can be power or distribution, either column-type or armored-type, and includes a magnetic core 110 and one or more transformation phases 120 contained inside a tank 130 and immersed in a dielectric fluid. Transformation phases 120 are wound around magnetic core 110 and are connected to high voltage terminals 140 and low voltage terminals 150 that extend externally to tank 130. Electric transformer 100 includes a central controller 160 that is arranged in an outer surface of tank 130 and which controls the operation of a stepped-impedance-tap selector (not shown) in connection with each transformation phase 120. One or more cooling systems 170 may be operatively coupled with electric transformer 100 and configured to maintain an operating temperature of the same electric transformer 100. The characteristic details of the configuration of the transformation phase 120 are seen later in the description of FIG. 2A and FIG. 2B, depending on whether the electric transformer 100 is column-type or armored-type.

Now referring to FIG. 2A, there is illustrated a perspective view of a first embodiment of a magnetic core 110 and its transformation phases 120 of a of a variable-impedance column-type electric transformer 100 in accordance with the present invention. In this embodiment, the magnetic core 110 is column-type, provided with a central column 111 and two lateral columns 112 and 113, all the columns being arranged substantially in the same plane. The three columns 111, 112 and 113 have their upper ends interconnected by an upper yoke 114, while their lower ends are interconnected by a lower yoke 115. The magnetic core 20 is advantageously made up of stacked sheets which are parallel to the plane at the which the three columns 111, 112 and 113 are located. The material, number and thickness of the plates that constitute the different columns 111, 112 and 113 and upper and lower yokes 114 and 115, can of course be selected according to the usual criteria for the design of magnetic cores.

Each transformation phase 120 is arranged and wound around each of the columns 111, 112 and 113 of the magnetic core 110. In the electric transformer 100 of the present invention, each transformation phase 120 is formed by conductive windings 121 (which may be, for example, a primary winding 121A and a secondary winding 121B), a first impedance-varying auxiliary winding 122 and a second impedance-varying auxiliary winding 123. The first impedance-varying auxiliary winding 122 and the second impedance-varying auxiliary winding 123 are galvanically connected in series and are wound in such a way that their respective impedance circuit modules (not shown) are interposed one by one. The conductive windings 121, the first impedance-varying auxiliary winding 122 and the second impedance-varying auxiliary winding 123 are wound around each of the columns 111, 112 and 113 of the magnetic core 110 and each of their spirals are insulated, by the use, for example, of dielectric paper. The first impedance-varying auxiliary winding 122 and the second impedance-varying auxiliary winding 123, in this embodiment, are arranged radially to the conductive windings 121, however, they may also be arranged axially to the conductive windings 121. It will be appreciated that multiple primary windings 121A, multiple secondary windings 121B, multiple first impedance-varying auxiliary windings 122, and multiple second impedance-varying auxiliary winding 123 could be used within each transformation phase 120.

Referring now to FIG. 2B, there is a perspective view of a second embodiment of a magnetic core 110 and its transformation phases 120 of a variable-impedance armored-type electric transformer 100 in accordance with the present invention. In this embodiment, the magnetic core 110 is armored-type, provided with a first section 110A and a second section 110B, arranged in a side-by-side relationship. Each section 110A and 110B of the magnetic core 110 has three openings for windings 116. The electric transformer 100 includes three transformation phases 120, each of which includes conductive windings 121 (which may be, for example, a primary winding 121A, a secondary winding 121B), a first impedance-varying auxiliary winding 122 and a second impedance-varying auxiliary winding 123 arranged in an interposed manner. The first impedance-varying auxiliary winding 122 and the second impedance-varying auxiliary winding 123 are galvanically connected in series and are wound such that their respective impedance circuit modules (not shown) are interposed one by one. The conductive windings 121, the first impedance-varying auxiliary winding 122, and the second impedance-varying auxiliary winding 123 are stacked in side-by-side relationship and wound to magnetic core 110 encompassing a portion of first section 110A and second section 110B in alignment with corresponding openings for windings 116 of first section 110A and second section 110B, in turn forming openings 117. it will be appreciated that multiple primary windings 121A, multiple secondary windings 121B, multiple first impedance-varying auxiliary winding 122 and multiple second impedance-varying auxiliary winding 123 could be used within each transformation phase 120.

In both FIG. 2A and FIG. 2B, each of the conductive windings 121 may be divided into voltage circuit modules and each voltage circuit module is connected to a voltage tap or contact and is formed by a plurality of segments or turns of the conductive winding 121 electrically connected in series. The number of voltage circuit modules and their respective number of segments or turns determine the permissible transformation ratio regulation band (electrical voltage regulation) of the electric transformer 100, which can be implemented by means of a stepped voltage tap selector (not shown) that is selectively and electrically coupled to the voltage taps of the voltage circuit modules. The voltage taps are provided with corresponding contact devices and these contacts are, for example, insulated cables or copper bars or other conductors.

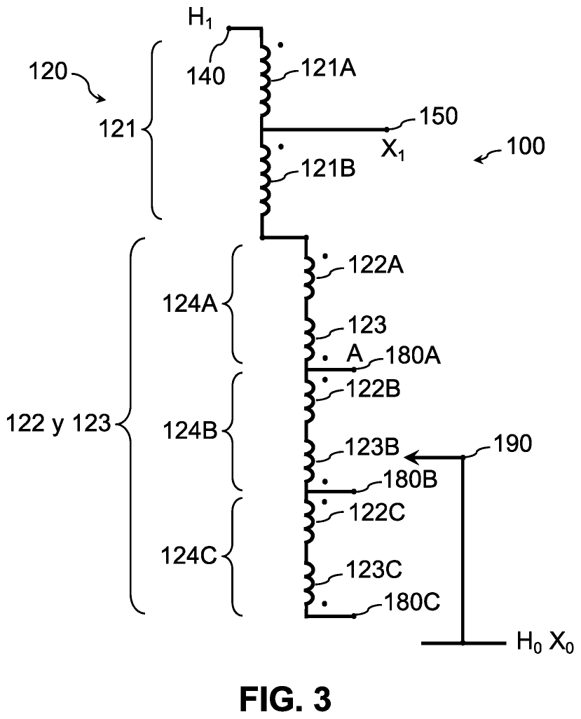

Now in FIG. 3, there is illustrated a circuit diagram of one embodiment of a transformation phase 120 of a variable-impedance electric transformer 100, either column-type or armored-type, in accordance with the present invention. The first impedance-varying auxiliary winding 122 is divided into impedance circuit modules 122A, 122B, and 122C, while the second impedance-varying auxiliary winding 123 is divided into impedance circuit modules 123A, 123B, and 123C. Each impedance circuit module 122A, 122B, and 122C of the first impedance-varying auxiliary winding 122 is formed by a plurality of segments or turns of the first impedance-varying auxiliary winding 122, while each impedance circuit module 123A, 123B, and 123C of the second impedance-varying auxiliary winding 123 is formed by a plurality of segments or turns of the second impedance-varying auxiliary winding 123.

The first impedance-varying auxiliary winding 122 and the second impedance-varying auxiliary winding 123 are of reverse magnetic polarity, that is, the first impedance-varying auxiliary winding 122 has a magnetic polarity and the second impedance-varying auxiliary winding 123 has an inverse magnetic polarity to the magnetic polarity of the first impedance-varying auxiliary winding 122.

The first impedance-varying auxiliary winding 122 and the second impedance-varying auxiliary winding 123 are connected in series, defining impedance variation modules 124A, 124B and 124C by interposing one by one their impedance circuit modules 122A, 122B, 122C, 123A, 123B and 123C to maintain inverse magnetic polarity between both impedance-varying auxiliary windings 122 and 123. Each impedance variation module 124A, 124B and 124C is formed by an impedance circuit module of the first impedance-varying auxiliary winding 122 connected in series, under a galvanic connection, to an impedance circuit module of the second impedance-varying auxiliary winding 123, that is to say the impedance variation module 124A includes the impedance circuit module 122A of the first impedance-varying auxiliary winding 122 and the impedance circuit module 123A of the second impedance-varying auxiliary winding 123; the impedance variation module 124B includes the impedance circuit module 122B of the first impedance-varying auxiliary winding 122 and the impedance circuit module 123B of the second impedance-varying auxiliary winding 123; and the impedance variation module 124C includes the impedance circuit module 122C of the first impedance-varying auxiliary winding 122 and the impedance circuit module 123C of the second impedance-varying auxiliary winding 123. Each impedance variation module 124A, 124B and 124C in turn is connected to an impedance tap 180A, 180B, and 180C, respectively. The impedance taps 180A, 180B and 180C are provided with corresponding contact devices and these contacts are for example insulated wires or copper bars or other conductors.

The number of impedance variation modules, the number of impedance circuit modules of the first impedance-varying auxiliary winding 122 and of the second impedance-varying auxiliary winding 123, and their respective number of segments or turns determine the permissible impedance regulation band of the transformation phase 120 or of the electric transformer 100 itself, which can be implemented by means of an stepped-impedance-tap selector 190 that selectively and electrically couples to the impedance taps 180A, 180B and 180C of the impedance variation modules 124A, 124B and 124C.

An operator can control the electric transformer 100 through a central controller 160. For example, central controller 160 can be placed at a location external to electric transformer 100 so that it can be accessed by the operator. The central controller 160 may also be referred to as a workstation or the like. Central controller 160 may include data processing circuitry, including one or more computer processors (e.g., microcontrollers) or other logic-based devices that perform operations based on one or more instruction sets (e.g., software). An operator can control the transformation ratio and/or a leakage reactance (leakage impedance) of the electric transformer 100 by controlling one or more processors of the central controller 160.

Central controller 160 may include, among other things, one or more input and/or output devices (for example, a keyboard, electronic mouse, printer, or the like), a graphical user interface or GUI, a voltage controller, and an impedance controller (not shown). The voltage controller and/or impedance controller may be solid state or mechanical switches, knobs, buttons, switches, a touch screen, or the like.

The voltage controller is electrically connected to the stepped-voltage-tap selector (not shown) of each transformation phase 120 of the electric transformer 100. For example, the stepped-voltage-tap selector may be a motorized system that may allow it to be select the voltage taps of the voltage circuit modules to change the transformation ratio of the transformation phase 120 or of the electric transformer 100.

The impedance controller is electrically connected to the stepped-impedance-tap selector 190 of each transformation phase 120 of the electric transformer 100. For example, the stepped-impedance-tap selector 190 can be a motorized system that can allow the selection of the impedance taps 180A, 180B and 180C of the impedance variation modules 124A, 124B and 124C, respectively, to vary the impedance of the transformation phase 120 or of the electric transformer 100, by controlling an amount of power passing through the electric transformer 100. Optionally, the impedance controller can be manipulated to change the impedance of the electric transformer 100 to control an amount of short-circuit current that is allowed to flow through the electric transformer 100. For example, the impedance controller can increase or decrease the amount of short-circuit current that is allowed to flow through electric transformer 100 or through each of the transformation phases 120. Optionally, the impedance controller can control the impedance of one or more transformation phases 120 to balance an amount of power that is allowed to flow through each of the transformation phases 120.

In one or more embodiments, the operator can manipulate the impedance controller to change the impedance of one or more of the transformation phases 120 or the impedance of the electric transformer 100 while the transformer phase 120 is in operation, i.e., under load. The impedance controller controls the operation of each stepped-impedance-tap selector 190. For example, the impedance controller commands the stepped-impedance-tap selector 190 to selectively mate with an impedance variation modules 124A, 124B, or 124C, where one impedance circuit modules 122A, 122B or 122C of this impedance variation module 124A, 124B or 124C belongs to the first impedance-varying auxiliary winding 122 and the other impedance circuit modules 123A, 123B or 123C of this impedance variation module 124A, 124B or 124C belongs to the second impedance-varying auxiliary winding 123 so as to vary the impedance of one or more of the transformation phases 120 or the impedance of the electrical transformer 100.

As illustrated in the FIG. 3 embodiment, impedance taps 180A, 180B, and 180C of impedance variation modules 124A, 124B, and 124C, respectively, are operatively coupled with the impedance controller (not shown) and the stepped-impedance-tap selector 190. An operator of electric transformer 100 can change the impedance of transformation phase 120 or electric transformer 100 by controlling stepped-impedance-tap selector 190. For example, for primary winding 121A it is made pass, through the high voltage terminal 140 (H₁) to which it is connected, a main current that induces a main magnetic flux in the magnetic core 110 to generate a transformation of the voltage through the secondary winding 121B outputting a current low voltage through the low voltage terminal 150 (X₁), so that under load the operator of the electric transformer 100 can change the impedance of the electric transformer 100 by changing a configuration of the impedance controller to connect an inner end of terminal H₀X₀ to any of the impedance taps 180A, 180B and 180C through the stepped-impedance-tap selector 190.

In one or more embodiments, the impedance controller of the central controller 160 may be a knob that can be turned to one or more settings to change the stepped-impedance-tap selector 190. Optionally, the impedance controller may be a keyboard, display touch or similar, so that the operator can modify, by selecting and/or entering a corresponding code, the configuration of the stepped-impedance-tap selector 190. A single selection, manipulation, indication or similar, by the operator through the impedance controller switches to any of the impedance taps 180A, 180B, and 180C with which the stepped-impedance-tap selector 190 is electrically coupled.

As the interconnection of the impedance circuit modules 122A, 122B and 122C of the first impedance-varying auxiliary winding 122 with the impedance circuit modules 123A, 123B and 123C of the second impedance-varying auxiliary winding 123, respectively, are corresponding to define the impedance variation modules 124A, 124B and 124C. As an example, the operator can use the impedance controller to vary the impedance of a transformation phase 120 to have a lower impedance leakage setting. By manipulating the impedance controller to control the electric transformer 100 to change the transformation phase 120 to have a lower impedance leakage setting, stepped-impedance-tap selector 190 may be electrically coupled with the first impedance tap 180A by whereby the lowest impedance value of the electric transformer 100 is obtained in relation to the connection of the impedance taps 180A, 180B and 180C. By changing the impedance of the electric transformer 100, an amount of power that can pass through the electric transformer 100 can be controlled. Additionally, or alternatively, by changing the impedance of the electric transformer 100, a permissible fault current level can be changed in the electric transformer 100. For example, the permissible fault current level may be a predetermined threshold that when occurred, the electric transformer 100 fails. By changing the impedance of the electric transformer 100, the permissible fault current level can be changed from the predetermined threshold to a threshold that has a higher value, or to a threshold that has a lower value.

Alternatively, the operator can use the impedance controller to change transformation phase 120 to have a higher impedance leakage setting. By manipulating the impedance controller to change the impedance to the higher setting, the stepped-impedance-tap selector 190 can be electrically coupled with the latest impedance tap 180C. For example, the stepped-impedance-tap selector 190 with the last impedance tap 180C, the highest impedance value of the electric transformer 100 is obtained relative to the connection of the impedance tap 180A and the impedance tap 180B. For example, the impedance controller changes the impedance of the electric transformer 100 by switching the impedance variation modules 124A, 1248 and 124C of the first impedance-varying auxiliary winding 122 and second impedance-varying auxiliary winding 123 that are connected to the conductive windings 121.

In the illustrated embodiment, the first impedance-varying auxiliary winding 122 includes three impedance circuit modules 122A, 1228 and 122C, and the second impedance-varying auxiliary winding 123 includes three impedance circuit modules 123A, 1238 and 123C such that the impedance circuit modules 122A, 1228, 122C, 123A, 1238 and 123C are connected in series in an interposed manner, defining the impedance variation modules 124A, 1248 and 124C. Optionally, in each transformation phase 120, the first impedance-varying auxiliary winding 122 can have any number of impedance circuit modules, while the second impedance-varying auxiliary winding 123 has the same number of impedance circuit modules as the number of impedance circuit modules of the first impedance-varying auxiliary winding 122. The same number of impedance circuit modules of the first impedance-varying auxiliary winding 122 and second impedance-varying auxiliary winding 123 allows the leakage reactance of the electric transformer 100 to change without affect the transformation ratio of the electric transformer 100. The impedance variation modules 124A, 1248, and 124C are designed with impedance taps 180A, 180B, and 180C to match a reactance value of the electric transformer 100 to changes in the position of the impedance variation modules 124A, 1248 and 124C. Furthermore, the position of the impedance variation modules 124A, 124B and 124C can be done while the electric transformer 100 is under load or online, i.e., in operation.

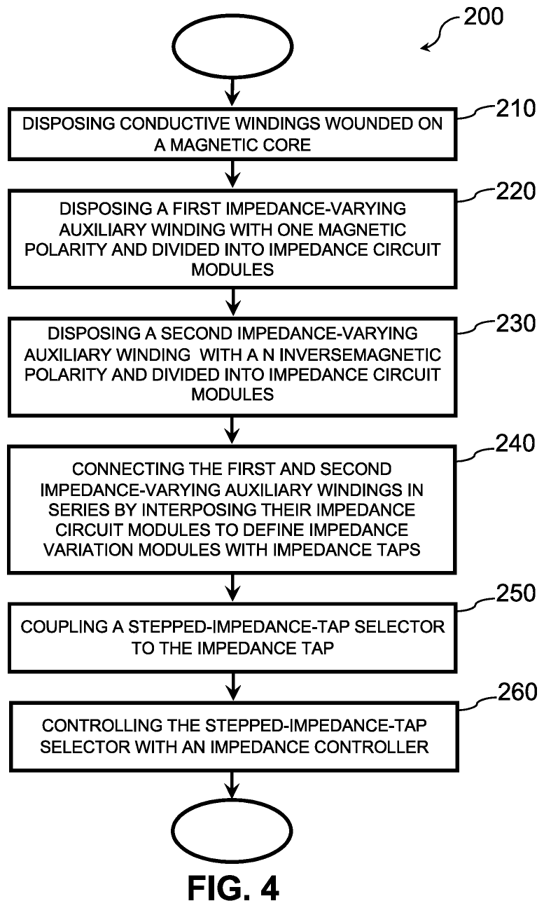

Referring now to FIG. 4 in conjunction with FIG. 3, a flowchart of a method 200 for varying impedance in an electric transformer 100 is shown. Certain steps in the method or in the flow of the method that are referenced from hereinafter naturally precede others for the invention to function as described. However, the invention is not limited to the order of the steps described if said order or sequence does not alter the functionality of the invention. That is, it is recognized that some steps may be performed before, after, or in parallel with other steps without departing from the scope or spirit of the invention.

In step 210, conductive windings 121 are disposed around the magnetic core 110 of the electric transformer 100.

In step 220, a first impedance-varying auxiliary winding 122 with a magnetic polarity divided into impedance circuit modules 122A, 122B and 122C is disposed around the conductive windings 121, said arrangement being radial or axial to the conductive windings 121.

In step 230, a second impedance-varying auxiliary winding 123 with an inverse magnetic polarity to the magnetic polarity of the first impedance-varying auxiliary winding 122 and divided into impedance circuit modules 123A, 123B and 123C is disposed around the conductive windings 121, said arrangement being radial or axial to the conductive windings 210.

In step 240, the first impedance-varying auxiliary winding 122 and the second impedance-varying auxiliary winding 123 are connected in series, interposing their impedance circuit modules 122A and 123A, 122B and 123B, 122C and 123C one by one to defining impedance variation modules 124A, 124B and 124C, respectively, each impedance variation module 124A, 124B or 124C includes an impedance circuit module 122A, 122B or 122C of the first impedance-varying auxiliary winding 122 connected in series with an impedance circuit module 123A, 123B, or 123C of the second impedance-varying auxiliary winding 123, and each impedance variation module 124A, 124B, and 124C has an impedance tap 180A, 180B, and 180C, respectively.

In step 250, a stepped-impedance-tap selector 190 is electrically coupled to the impedance taps 180A, 180B, and 180C of the impedance variation modules 124A, 124B, and 124C.

And finally, in step 260, the stepped-impedance-tap selector 190 is controlled, by means of an impedance controller, to vary the impedance of the transformation phase 120 or of the electric transformer 100, it being possible to perform the variation of the impedance while the electric transformer 100 is under load.

From the embodiments described above, it appears that the method 200 for varying the impedance in an electric transformer 100 in accordance with the present invention is applicable to any configuration and number of transformation phases 120 of the electric transformer 100, as observed in all the embodiments described here.

Proceeding with a variation in the impedance of one or more transformation phases 120 or electric transformer 100 can be decided when, for example, transformation phase 120 can be a replacement transformation phase that can be installed within electric transformer 100. The electrical transformer 100 may have a current leakage impedance level, and the impedance of the replacement transformation phase may need to substantially match the leakage impedance level of electric transformer 100. As another example, the impedance may need to be changed in one or more transformation phases 120 of a multiphase electric transformer 100 to balance an amount of power configured to flow through each of the transformation phases 120 of the multiphase electric transformer 100. As another example, an amount of power passing through electric transformer 100 may need to be changed (e.g., increased or decreased). Changing the impedance of the electric transformer 100 changes the amount of power that passes through the electric transformer 100. As another example, a fault current level of the electric transformer 100 may need to be changed. Changing the impedance of the electric transformer 100 changes the fault current level of the amount of current that can pass through the electric transformer 100. Optionally, it may be necessary to change the impedance of the electric transformer 100 for any alternate purpose.

Based on the embodiments described above, it is contemplated that modifications to the described embodiment environments, as well as alternative embodiment environments, will be considered obvious to a person skilled in the art under the present description. It is, therefore, contemplated that the claims encompass such modifications and alternatives that fall within the scope of the present invention or their equivalents.

1. A variable-impedance electric transformer, comprising one or more transformation phases wounding around a magnetic core, wherein at least one transformation phase includes:
conductive windings;
a first impedance-varying auxiliary winding divided into impedance circuit modules, the first impedance-varying auxiliary winding having a magnetic polarity;
a second impedance-varying auxiliary winding divided into impedance circuit modules, the second impedance-varying auxiliary winding having an inverse magnetic polarity to the magnetic polarity of the first impedance-varying auxiliary winding;
wherein the first impedance-varying auxiliary winding and second impedance-varying auxiliary winding are connected in series, defining impedance variation modules by interposing the impedance circuit modules one by one, each impedance variation module includes one impedance circuit modules of the first impedance-varying auxiliary winding connected in series with one impedance circuit modules of the second impedance-varying auxiliary winding, and each impedance variation module having a impedance tap;
a stepped-impedance-tap selector configured to be electrically coupled to the impedance taps of the impedance variation modules; and
an impedance controller configured to control the stepped-impedance-tap selector for varying the impedance of the transformation phase or the electric transformer.

2. The electric transformer of claim 1, wherein the electric transformer is a column-type or armored-type electric transformer.

3. The electric transformer of claim 2, wherein the electric transformer is a column-type electric transformer, and the first impedance-varying auxiliary winding and second impedance-varying auxiliary winding are arranged radially or axially to the conductive windings.

4. The electric transformer of claim 2, wherein the electric transformer is armored-type electric transformer, and the first impedance-varying auxiliary winding and second impedance-varying auxiliary winding are arranged in a stacked manner in side-by-side relationship to the conductive windings.

5. The electric transformer of claim 1, wherein the conductive windings are a primary winding and a secondary winding.

6. The electric transformer of claim 1, wherein the impedance controller is configured for varying the impedance of at least one transformation phase or the electric transformer under load.

7. The electric transformer of claim 1, wherein the electric transformer is a power or distribution electric transformer.

8. The electric transformer of claim 1, wherein the electric transformer is a single-phase or multi-phase transformer.

9. A method for varying the impedance in an electric transformer comprising one or more transformation phases wounding around a magnetic core, the method comprising the steps of:
disposing conductive windings;
disposing a first impedance-varying auxiliary winding divided into impedance circuit modules, the first impedance-varying auxiliary winding having a magnetic polarity;
disposing a second impedance-varying auxiliary winding divided into impedance circuit modules, the second impedance-varying auxiliary winding having an inverse magnetic polarity to the magnetic polarity of the first impedance-varying auxiliary winding;
connecting the first impedance-varying auxiliary winding and second impedance-varying auxiliary winding in series, by interposing the impedance circuit modules one by one for defining impedance variation modules, each impedance variation module includes one impedance circuit modules of the first impedance-varying auxiliary winding connected in series with one impedance circuit modules of the second impedance-varying auxiliary winding, and each impedance variation module having an impedance tap;
electrically coupling a stepped-impedance-tap selector to the impedance taps of the impedance variation modules; and
controlling, by an impedance controller, the stepped-impedance-tap selector for varying the impedance of the transformation phase or the electric transformer.

10. The method of claim 9, wherein the step of disposing a first impedance-varying auxiliary winding divided into impedance circuit modules, the first impedance-varying auxiliary winding is arranged radially or axially to the conductive windings when the electric transformer is of the column type.

11. The method of claim 9, wherein the step of disposing a second impedance-varying auxiliary winding divided into impedance circuit modules, the second impedance-varying auxiliary winding is arranged radially or axially to the conductive windings when the electric transformer is a column-type electric transformer.

12. The method of claim 9, wherein the step of disposing a first impedance-varying auxiliary winding divided into impedance circuit modules, the first impedance-varying auxiliary winding is arranged in a stacked manner in side-by-side relationship to the conductive windings when the electric transformer is an armored-type electric transformer.

13. The method of claim 9, wherein the step of disposing a second impedance-varying auxiliary winding divided into impedance circuit modules, the second impedance-varying auxiliary winding is arranged in a stacked manner in side-by-side relationship to the conductive windings when the electric transformer is an armored-type electric transformer.

14. The method of claim 9, wherein the step of controlling by an impedance controller the stepped-impedance-tap selector for varying the impedance of the transformation phase or the electric transformer, the impedance controller is configured for varying the impedance of at least one transformation phase or the electric transformer under load.
